(19) United States
(12) Patent Application Publication
(10) Pub. No.: US 2013/0316244 A1
(43) Pub. Date: Nov. 28, 2013

(54) ELECTRODE FOR LITHIUM ION BATTERIES AND THE METHOD FOR MANUFACTURING THE SAME

(71) Applicants: Jingjun Zhang, Shanghai (CN); Longjie Zhou, Shanghai (CN); Jun Yang, Shanghai (CN); Haiping Jia, Shanghai (CN)

(72) Inventors: Jingjun Zhang, Shanghai (CN); Longjie Zhou, Shanghai (CN); Jun Yang, Shanghai (CN); Haiping Jia, Shanghai (CN)

(21) Appl. No.: 13/989,268

(22) PCT Filed: Nov. 23, 2011
(86) PCT No.: PCT/CN11/82696

§ 371 Date: Aug. 9, 2013

(30) Foreign Application Priority Data
Nov. 25, 2010 (CN) 201010574779.X

(51) Int. Cl. H01M 4/36; H01M 4/04

(52) U.S. Cl. CPC H01M 4/364; H01M 4/0471
USPC 429/231.8; 252/502

(57) ABSTRACT

An electrode is formed of a ternary composite of silicon, carbon, and carbon filter foil, for lithium ion batteries. Also described is a method for manufacturing silicon/carbon/carbon fiber foil composite electrode for lithium batteries, including: mixing silicon and an organic substance capable of forming carbon after heat treatment, in a solvent, to form a slurry; immersing the carbon fiber foil in said slurry until the slurry coats on and penetrates into the carbon fiber foil; and heating the carbon fiber foil, which has been coated and penetrated with the slurry, in an inert gas atmosphere or all inert gas atmosphere mixed with a reductive gas at a temperature of at least 400° C. for at least 2 hours.

### FIELD OF THE INVENTION

The present invention relates to an electrode, in particular to an electrode for lithium ion batteries formed of a ternary composite of silicon, carbon, and carbon fiber foil. The present invention also relates to the manufacture method of said electrode.

### BACKGROUND INFORMATION

Nowadays, lithium ion batteries are commonly used in devices or tools, such as cell-phones, notebooks, cameras, power tools, etc. Graphite is the most important cathode material for lithium ion batteries. As more attention are paid to electric vehicles in automotive industry, the development of lithium ion batteries with high energy density has become an urgent need for electric vehicle industry. Relatively low capacity for storing lithium ions of current graphite cathodes is an important reason for the relatively low energy density of batteries.

Now, the researchers have realized that if the graphite is replaced with silicon composites, the capacity of the cathode of lithium ion batteries could be increased by many times. It has been suggested to replace graphite with silicon/carbon composites in the prior art. Conventional silicon/carbon composites, commonly manufactured by pyrolysis, mechanical mixing and high energy ball milling, or combination thereof, consist of Si particles embedded in a dense carbon matrix. However, the volume change effect of Si can only be inhibited to a limited degree by silicon/carbon composites manufactured with such method, thus only limited stability and cycle life can be offered. Structural breaking and powdering tend to occur if lithium ions are embedded into the structure of silicon material during the charge and discharge cycles. As a result, the cycling ability of the battery would be very poor.

Also disclosed in the prior art is a composite electrode formed by a silicone/carbon active layer and a rigid copper current collector layer. As for cathode materials of lithium batteries with large volume effect, such as silicon, a significant volume change would occur in the silicon/carbon active layer during the charge and discharge cycle, which produces a strong mechanical stress not only inside the active layer but also between the silicon/carbon active layer and the rigid copper current collector layer, and in turn causes powdering and scaling off of the silicon material, breaking of the electric contact between particles of the material and between the coating layer and the copper current collector, and significant decrease of the charge and discharge capacity. As a result, the battery fails rapidly.

Therefore, a cathode for lithium ion batteries, which can overcome the above defects, is in urgent need, so as to solve the problems such as significant decrease of charge and discharge capacity and rapid failure of the battery and allow lithium batteries to be widely applied in hybrid electric vehicles, plug-in hybrid electric vehicles and pure electric vehicles.

### SUMMARY OF THE INVENTION

According to an aspect, the present invention provides an electrode for lithium ion batteries, which is composed of a ternary composite of silicon, carbon, and carbon fiber foil.

In an embodiment, said carbon is elementary carbon.

In another embodiment, said carbon is formed by heat treatment of organic substances capable of forming carbon after heat treatment.

In an embodiment, the weight ratio of silicon and carbon in the electrode is in the range of 4.0-0.1, which may be 2.33-0.50.

In another embodiment, the total weight content of silicon and carbon in the electrode is >20%, based on the total weight of the ternary composite of silicon/carbon/carbon fiber foil.

According to another aspect, the present invention further provides a method for manufacturing silicon/carbon/carbon fiber foil composite electrode, comprising the following:
A. mixing silicon and an organic substance capable of forming carbon after heat treatment, in a solvent, to form a slurry;
B. immersing the carbon fiber foil in said slurry until the slurry coats on and penetrates into the carbon fiber foil; and
C. heating the carbon fiber foil, which has been coated and penetrated with the slurry, in an inert gas atmosphere or an inert gas atmosphere mixed with a reductive gas at a temperature of at least 400° C. for at least 2 hours.

In an embodiment of the method of the present invention, the organic substance capable of forming carbon after heat treatment in step A refers to any organic substance known in the art, provided that it can form carbon after heat treatment. It may be any substance selected from the group consisting of asphalt, polyvinyl chloride, polyacrylonitrile, phenolic resin, and sucrose.

In an embodiment of the method of the present invention, the inert gas employed in step C is argon (Ar), the reductive gas is hydrogen (H₂). The volume ratio of argon and hydrogen may be 90-100:10-0.

In step C of the method of the present invention, the process of heating in an inert gas atmosphere or an inert gas atmosphere mixed with a reductive gas may be carried out at a temperature of 400-1000° C. for at least 2 hours.

The present invention is further described by the following drawings.

### BRIEF DESCRIPTION OF THE DRAWINGS

FIG. 1a shows a photograph of the carbon fiber foil.

FIG. 1b shows a scanning electron microscope photograph of the carbon fiber foil, with a magnification factor of 250.

FIG. 1c shows a scanning electron microscope photograph of the silicon/carbon/carbon fiber foil composite electrode of the present invention, with a magnification factor of 250.

FIG. 2 shows a comparative schematic diagram illustrating the charge and discharge cycling performance of the silicon/carbon/carbon fiber foil composite electrode manufactured by the method according to the present invention (electrode No. 1), the silicon/carbon/carbon fiber foil composite electrode manufactured by prior art methods (electrode No. 2), and the silicon/carbon/copper foil composite electrode manufactured by prior art methods (electrode No. 3).

FIG. 3 shows a comparative schematic diagram illustrating the charge and discharge cycling performance of silicon/carbon/carbon fiber foil composite electrodes with different weight contents of silicon/carbon (electrodes No. 1, 4, and 5).

### DETAILED DESCRIPTION

In the first aspect, the present invention relates to a novel electrode for lithium ion batteries, formed of a ternary composite of silicon, carbon, and carbon fiber foil (hereinafter referred to as “ternary composite”).

As used herein, the term “ternary composite” refers to a ternary composite formed by distribution of silicon and carbon in voids of the carbon fiber foil. The carbon distributed in the carbon fiber foil may be elementary carbon in any forms or any organic compound capable of forming carbon after heat treatment.

As used herein, the term “silicon” refers to elementary silicon, which may be, e.g., monocrystalline silicon, polycrystalline silicon, amorphous silicon, and the like. The smaller the particle of elementary silicon, the better its performances.

As used herein, the term “carbon” refers to elementary carbon, and may be formed of an organic substance capable of forming carbon after heat treatment. The organic substance capable of forming carbon after heat treatment refers to any organic substance known in the art, provided that it can form carbon after heat treatment. It may be any substance selected from the group consisting of asphalt, polyvinyl chloride, polyacrylonitrile, phenolic resin, and sucrose, etc., and may be polyvinyl chloride (PVC).

In the electrode according to the present invention, the ratio of silicon and carbon can be determined, according to the performances of the final product, by those skilled in the art. For example, the content of silicon may be increased in order to increase the electric capacity of the electrode. On the contrary, the content of carbon may be increased in order to increase the stability and cycle life of the electrode. The weight ratio of silicon and carbon in the electrode according to the present invention may be in the range of 4.0-0.1, may be 2.5-0.25, and may be 2.33-0.50. The possibility of structural breaking and powdering of the electrode may be increased if the content of silicon is too high; and the capacity of the electrode may be decreased if the content of carbon is too high.

In the electrode of the present invention, the total weight content of silicon and carbon, based on the total weight of the ternary composite of silicon, carbon and carbon fiber foil, may be determined, according to the final demand of the electrode, by those skilled in the art. For example, if the mechanical stability of the electrode may be considered, the weight content of silicon and carbon should be decreased. On the contrary, if the capacity and cycling performance of the electrode may be considered, the weight content of silicon and carbon may be suitably increased. The total weight content of silicon and carbon may be >20%, based on the total weight of the ternary composite of silicon, carbon, and carbon fiber foil.

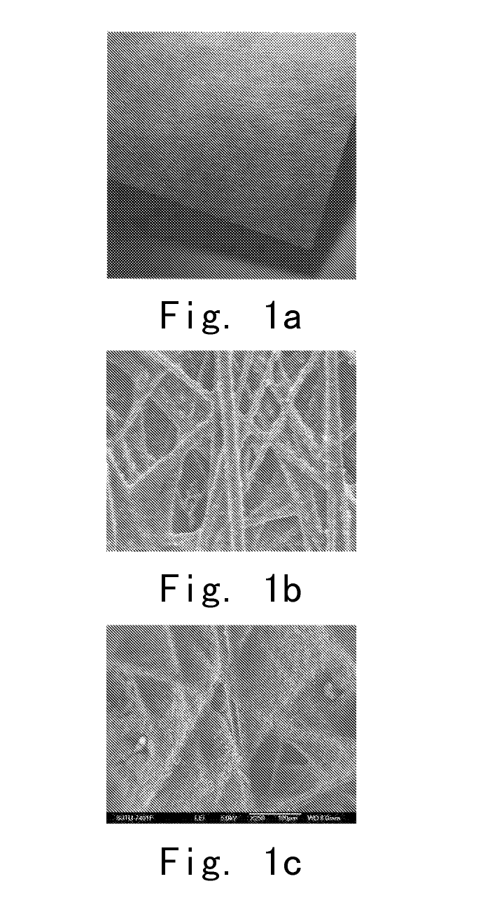

The carbon fiber foil used in the present invention, as a part of the silicon/carbon/carbon fiber foil composite electrode for lithium ion batteries, unlike conventional copper foil, is a weaved layer of carbon fiber with a porous structure. In particular, as used herein, the term “carbon fiber foil” refers to a carbon fiber foil with voids, in which carbon fibers intercross and overlap each other and form a porous structure. Said carbon fiber foil includes many kinds of carbon fibers manufactured from various starting materials and by various processes, such as those of the model TGP-H-030 (Toray, Japan). Referring to FIG. 1a and 1b, which illustrate the structure of a carbon fiber foil according to an embodiment, it can be seen from figure lb that there are voids among the fibers. The carbon fiber foil is relatively thin. The carbon fiber foil may be in any shapes, such as circle, square, or irregular shapes, and can be determined as required.

Referring to FIG. 1c, it illustrates the structure of a ternary composite according to an embodiment of the present invention. In the ternary composite, silicon and carbon are coated on the carbon fiber foil and penetrates into the voids of the carbon fiber foil.

According to another aspect, the invention relates to a method for manufacturing silicon/carbon/carbon fiber foil composite electrodes, comprising the steps of:
A. mixing silicon and an organic substance capable of forming carbon after heat treatment, in a solvent, to form a slurry;
B. immersing the carbon fiber foil in said slurry until the slurry coats on and penetrates into the carbon fiber foil; and
C. heating the carbon fiber foil, which has been coated and penetrated with the slurry, in an inert gas atmosphere or an inert gas atmosphere mixed with a reductive gas at a temperature of at least 400° C. for at least 2 hours.

In step A of the above mentioned method, the starting materials of silicon and the organic substance capable of forming carbon after heat treatment are firstly mixed in a solvent, if appropriate, with stirring, to form a slurry. As used herein, the starting material “organic substance capable of forming carbon after heat treatment” refers to any organic substance known in the art, provided that it can form carbon after heat treatment. It may be any substance selected from the group consisting of asphalt, polyvinyl chloride, polyacrylonitrile, phenolic resin, sucrose, etc., and may be polyvinyl chloride. The solvent can be any suitable solvent, provided that it does not react with the starting materials, i.e. the organic substance capable of forming carbon after heat treatment or silicon. The solvent may be a volatile solvent. The solvent may be, e.g., acetone, cyclohexanone, N,N-dimethylfomamide (DMF), tetrahydrofuran (THF), water, etc., and may be THF.

In step A, the weight ratio of the starting materials of silicon and the organic substance capable of forming carbon after heat treatment, can be determined according to the desired final product electrode. Firstly, the carbon in the electrode of the present invention is formed by heat treatment, such that the carbonization rate of the organic substance capable of forming carbon after heat treatment, can be calculated experimentally, and the weight of the organic substance in the starting material can be calculated from the weight of carbon in the desired final product electrode, so that the weight ratio of the starting materials of silicon and the organic substance capable of forming carbon after heat treatment can be determined by the weight ratio of silicon and carbon in the configured electrode. For instance, in case that polyvinyl chloride is employed as the organic substance, the inventor has experimentally determined that a certain polyvinyl chloride has a carbonization rate of 17% after heat treatment, such that the weight ratio of silicon and polyvinyl chloride in the starting material can be determined by the weight ratio of silicon and carbon in the configured electrode.

In the electrode manufactured according to the present invention, the weight ratio of silicon and carbon is in the range of 4.0-0.1, which may be 2.5-0.25, and may be 2.33-0.50. The weight ratio of the starting materials of silicon and the organic substance capable of forming carbon after heat treatment, can be selected accordingly. For instance, in the case that the organic substance is polyvinyl chloride, the weight ratio of the starting materials of silicon and polyvinyl chloride, could be 0.40, and the weight ratio of silicon and carbon in the electrode of the present application is 2.33, accordingly.

After the starting materials of silicon and the organic substance capable of forming carbon after heat treatment is mixed in a solvent, the mixture may be stirred, e.g., by such arrangements as mechanical stirring or ultrasonic stirring, to mix the mixture homogenously and form a slurry. Although the stirring time is not strictly restricted, it may be at least 20 minutes, and may be at least 30 minutes.

In step B, the carbon fiber foil is immersed in said slurry after the slurry has been formed, such that the slurry coats on and penetrates into the carbon fiber foil. The carbon fiber foil being employed may be in any form, such as circle, square, or irregular forms, which can be determined as required.

In step C, the carbon fiber foil, which has been coated and penetrated with the slurry, is heated in an inert gas atmosphere or an inert gas atmosphere mixed with a reductive gas at a temperature of at least 400° C., which may be 600-1000° C., and may be 800-1000° C., for at least 2 hours, such that the organic substance capable of forming carbon after heat treatment is completely carbonized and silicon and carbon are completely combined with the carbon fiber foil.

Any inert gas atmosphere, such as helium, neon, argon, krypton, xenon, or nitrogen, or mixed gases thereof, which may be argon, nitrogen, etc., can be employed in the process. The inert gas need not contain oxygen, and it may be that an inert gas with high purity is employed, in order to prevent oxidation. In order to completely avoid the influence of the oxygen possibly presented in the solvent and inert gas, a mixed gas atmosphere of inert gas and a small amount of reductive gas may be employed, wherein the reductive gas may be H₂. The mixed gas atmosphere of inert gas and a small amount of reductive gas may be a mixed gas of argon and hydrogen. The ratio of the inert gas and the reductive gas may be 90-100:10-0.

Although the heating time in step C is not strictly restricted, it is typically 2 hours, and can be determined as required.

In step C, the carbon fiber foil, which has been coated and penetrated with the slurry, can be optionally dried before heating. Said drying process can be carried out at room temperature or higher, which may be 50-70° C. The drying time is not strictly restricted, provided the solvent is substantially volatilized, which may be, the drying process is carried out for at least 4 hours.

As compared with prior art electrodes formed of silicon, carbon, and copper foils, the silicon/carbon/carbon fiber foil composite electrode of the present invention has a significantly improved cycling performance. The present invention provides a fundamental solution to the problem of the generation of mechanic stress between silicon carbon active layer and rigid copper foil current collector layer, and improve the cycle life of the electrode accordingly. For instance, as shown in example 2 (electrode No. 4), the electrode is capable of performing hundreds of lithium insertion/extraction cycles under high current density (0.5 C). Moreover, even if 90 cycles are performed, the conservation rate of the capacity is at least 84.2% and the specific capacity is at least 977 mAh/g.

The following examples further illustrate the invention. As used herein, unless otherwise specified, all ratios and percentages used in the present invention are on weight basis.

### EXAMPLES

### Example 1

### Silicon/Carbon/Carbon Fiber Foil Electrode Manufactured According to the Method of the Present Invention (Electrode No. 1)

The starting material silicon (silicon powder, 50 nm, 99.5%, Nanjing Emperor Nano Material Co., Ltd., Nanjing, China) and PVC (polyvinyl chloride, Mw=˜233,000 g/mol, Aldrich) (the weight ratio of Si/PVC is 1:4) were mixed in THF and stirred under ultrasonication for 30 min to form a slurry. Then carbon fiber foil (a small circle with D=12 mm, TGP-H-030, thickness=110 μm Toray) was immersed in the slurry, and the slurry was further ultrasonicated for 1 min until it coated on and penetrated into the carbon fiber foil. After being dried at 60° C. for 5 h, the coated and penetrated carbon fiber foil was then heated under a H₂—Ar atmosphere (5 vol. % H₂, 95 vol. % Ar) at 900° C. for 2 h, to obtain a silicon/carbon/carbon fiber foil composite electrode (electrode No. 1) formed of the ternary composite of silicon/carbon/carbon fiber foil. The mass load of the silicon/carbon on the carbon fiber foil is about 25% by weight. The weight ratio of silicon and carbon in the electrode is calculated to be 2.33, on the basis of the carbonization rate of the polyvinyl chloride.

### Comparative Example 1

### Silicon/Carbon/Copper Foil Electrode Manufactured According to Prior Art Method (Electrode No. 3)

The starting material silicon (the same as example 1) and PVC (the same as example 1) (the weight ratio of Si/PVC is 1:4) were mixed in THF and stirred under ultrasonication for 30 min to form a preliminary slurry. Then, the resulting preliminary slurry was sprayed onto a flat glass surface and dried at 80° C., and the obtained precursor was heated under a H₂—Ar atmosphere (5 vol. % H₂, 95 vol. % Ar) at 900° C. for 2 h. The resulting material was named as active material for further use. A slurry was prepared using 80 wt. % the active material, 10 wt. % polyvinylidene fluoride (PVDF) binder (Aldrich), and 10 wt. % carbon black (Super P, 40 nm, Timcal) as the conducting agent, in a solution of N-methyl-2-pyrrolidone (NMP). The slurry was coated on a copper foil to obtain a homogeneous layer. After coating, the homogeneous layer was dried at 80° C. for 10 mins to remove the solvent of NMP. Then, a circle piece of electrode with a diameter of 12 mm was cut off from the dried layer as Electrode No. 3. It was then further dried at 100° C. for 6 h. The mass load of silicon/carbon on the copper foil is about 20%. The weight ratio of silicon and carbon in the electrode is calculated to be 2.33, on the basis of the carbonization rate of the polyvinyl chloride.

### Comparative Example 2

### Silicon/Carbon/Carbon Fiber Foil Electrode Manufactured According to Prior Art Method (Electrode No. 2)

A carbon fiber foil (a small circle with a diameter of 12 mm) was immersed in the slurry prepared in comparative example 1, and then the slurry was ultrasonicated for 1 min until it coated on and penetrated into the carbon fiber foil. The foil was then further dried at 100° C. for 6 h to form Electrode No. 2. The mass load of silicon/carbon on the carbon fiber foil is about 60 wt. %. The weight ratio of silicon and carbon in the electrode is calculated to be 2.33, on the basis of the carbonization rate of the polyvinyl chloride.

### Example 2 and Example 3

### Silicon/Carbon/Carbon Fiber Foil Electrode Manufactured According to the Method of the Present Application (Electrode No. 4 and Electrode No. 5)

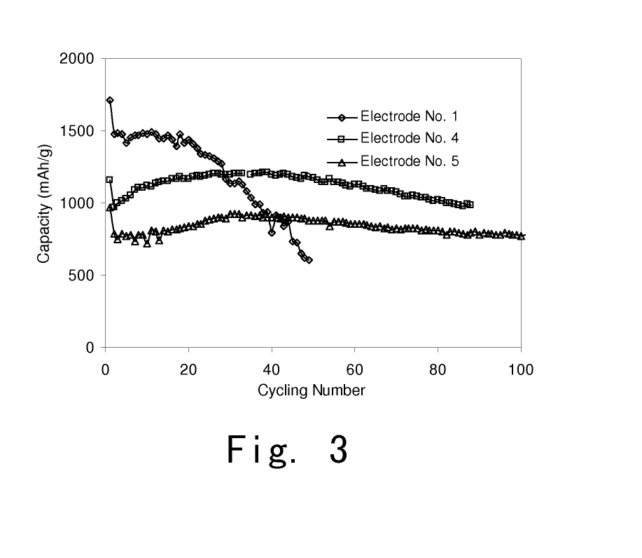

Electrode No. 4 and electrode No. 5 were manufactured according to a method similar to example 1, except that the weight ratio of silicon and carbon in electrode No. 4 was 1.17 and that in electrode No. 5 was 0.50; and the mass loads of silicon/carbon on the carbon fiber foil in electrode No. 4 and electrode No. 5 were about 25 wt. %. The electrochemical performances of electrode No. 1, electrode No. 4 and electrode No. 5 were showed in FIG. 3.

CR2016 coin-type cells were assembled in an argon-filled glove box (MB-10 compact, MBRAUN) with electrodes No. 1, 2, 3, 4 and 5 as the working electrodes, respectively, metallic lithium as the counter electrode, 1 mol/L LiPF₆ in EC:DMC (ethylene carbonate (EC):dimethyl carbonate (DMC), volume ratio of 1:1) as electrolyte, and ET20-26(Entek) as separator.

### Example of the Electrochemical Test

The charge and discharge tests were conducted on a LAND battery test system (Wuhan Kingnuo Electronics Co. Ltd., China) at 25° C. with a current density of 0.5 mA/mg. The cut-off voltage was 0.01 V versus metallic lithium for discharge (Li insertion) and 1.2 V versus metallic lithium for charge (Li extraction).

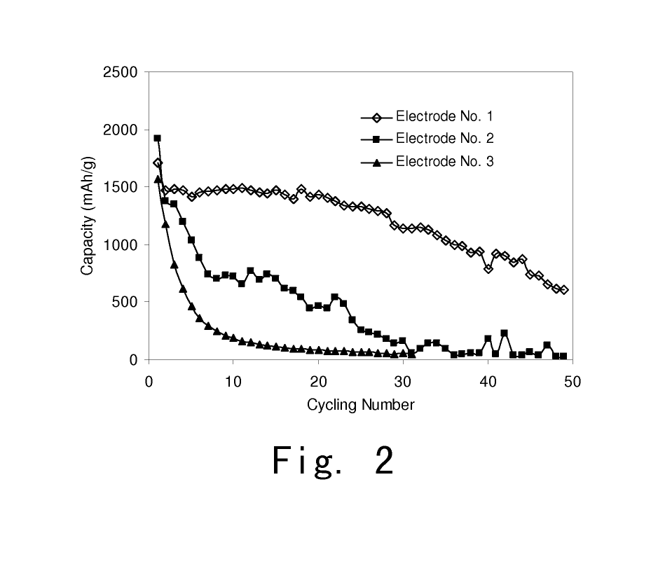

The electrochemical performances of electrodes No. 1-3 were shown in FIG. 2. FIG. 2 illustrates the cycling number and capacity of the cells with electrodes No. 1-3 as the working electrodes, respectively.

As shown in FIG. 2, under the same manufacture condition, as compared to the silicon/carbon/copper foil electrode manufactured according to the prior art methods (electrode 3) in comparative example 1, the silicon/carbon/carbon fiber foil electrode manufactured by using carbon fiber foil instead of copper foil (electrode 2) in comparative example 2 has a higher capacity and cycle life. Moreover, the silicon/carbon/carbon fiber foil composite electrode manufactured according to the method of the present invention in example 1 has a highest electric capacity and cycle life.

The electrochemical performances of electrodes No. 1, 4 and 5 are shown in FIG. 3. FIG. 3 illustrates the cycling number and capacity of the cells with electrodes No. 1, 4 and 5 as the working electrodes, respectively.

As shown in FIG. 3, in the electrodes of the present invention, the ratio of silicon/carbon significantly influences the performances of the electrodes. The higher the silicon content in the electrode, the larger the capacity of the electrode and the shorter the cycle life; the lower the silicon content, the smaller the capacity of the electrode and the longer the cycle life.

The above examples only serve to illustrate the invention but do not restrict the scope of the invention in any manner. On the contrary, it should be understood that any embodiments and modification may be made by a person skilled in the art without departing from the spirit of the present invention upon reading the foregoing description.

1-11. (canceled)

12. An electrode for a lithium ion battery, comprising:
an electrode arrangement formed of a ternary composite of silicon, carbon, and carbon fiber foil.

13. The electrode of claim 12, wherein the carbon is elementary carbon.

14. The electrode of claim 12, wherein the carbon is formed by heat treatment of an organic substance capable of forming carbon after the heat treatment.

15. The electrode of claim 13, wherein the weight ratio of silicon and carbon is in the range of 4.0-0.1.

16. The electrode of claim 15, wherein the weight ratio of silicon and carbon is in the range of 2.33-0.50.

17. The electrode of claim 12, wherein the total weight content of silicon and carbon is >20%, based on the total weight of the ternary composite of silicon, carbon, and carbon fiber foil.

18. A method for manufacturing a silicon/carbon/carbon fiber foil composite electrode for a lithium ion battery, the method comprising:
mixing silicon and an organic substance capable of forming carbon after heat treatment, in a solvent, to form a slurry;
immersing the carbon fiber foil in said slurry until the slurry coats on and penetrates into the carbon fiber foil; and
heating the carbon fiber foil, which has been coated and penetrated with the slurry, in an inert gas atmosphere or an inert gas atmosphere mixed with a reductive gas at a temperature of at least 400° C. for at least 2 hours.

19. The method of claim 18, wherein the organic substance capable of forming carbon after heat treatment includes one of asphalt, polyvinyl chloride, polyacrylonitrile, phenolic resin, and sucrose.

20. The method of claim 18, wherein the inert gas is argon and the reductive gas is hydrogen.

21. The method of claim 20, wherein the ratio of argon and hydrogen is 90-100:10-0.

22. The method of claim 18, wherein the heating in an inert gas atmosphere or an inert gas atmosphere mixed with a reductive gas in step C is carried out at a temperature of 400-1000° C. for at least 2 hours.
